(19) United States
(12) Patent Application Publication
(10) Pub. No.: US 2012/0227906 A1
(43) Pub. Date: Sep. 13, 2012

(54) HIGH-SPEED OUTSERT PLACER

(76) Inventor: Thomas Basgil, Cinnaminson, NJ (US)

(21) Appl. No.: 13/042,422

(22) Filed: Mar. 7, 2011

(51) Int. Cl. B65C 9/22

(52) U.S. Cl. 156/357

(57) ABSTRACT

An outserter for the pharmaceutical industry which can automatically apply an outsert (professional information brochure) to the outside of a pharmaceutical container without the need for webs, pressure sensitive tapes, a vacuum wheel, or a vacuum star to deliver an outsert from an outsert magazine to a designated container.

### FEDERALLY SPONSORED RESEARCH

This invention was not the subject of any federally sponsored research or development.

### BACKGROUND OF THE INVENTION

Packaging equipment is commonly used for the filling of containers, the closure of the containers, and the labeling of containers. Examples of containers in frequent use are the bottles or boxes found on the shelves in the marketplace. The bottles are used to package food and other items for both the home and industry. Such packages are provided with labels to identify the contents of the package, as well as to provide instructions for the use of the material contained within the package.

A problem arises in that there are occasions wherein there is insufficient room on a package label to provide all of the necessary data and instructions for the use of the material contained within the package. For example, in the distribution of medicinal products, literature or “outserts” in the nature of a multi-folded paper are attached to the package; unlike the usual label, such multi-folded paper has adequate space to fully describe the material being packaged and/or its use. The outsert has the description of the drug, side effects and all of the necessary legal information that must be provided by the pharmaceutical company to the end user. However, the securing of literature, such as the foregoing multi-folded paper or a brochure of bound sheets of paper, is not readily accomplished by the type of mechanism utilized for applying a simple, single layer label. The bulkiness of the literature and its tendency to open, necessitates the use of specially constructed equipment which can handle the folded or bound literature.

The known literature-applying machines have a number of problems. One such system is described in U.S. Pat. No. 4,853,063 which utilizes a web of pressure sensitive tape to move literature from a literature magazine to the target container. Web breaks and adjustment of the literature stop pins create constant attendance. Tension of the web is critical because too much tension causes web breaks, while not enough tension may cause the web to sag.

An additional problem with prior art outserters centers on the step of removing the literature from a magazine hopper and placing it on the web in a consistent manner. Such conventional literature-applying machines use a reciprocating or rotary mechanism that takes the literature out of a hopper using a vacuum, turns the literature at an angle of 90 degrees with respect to the web, and then releases the vacuum, thus adhering the literature to the web. One such machine utilizes a vacuum star wheel to pull the outsert out of a magazine hopper. However, this type of mechanism does not apply the literature to the web with consistent accuracy, and must be rebuilt frequently due to constant mechanical wear.

Literature may also be applied to containers using glue machines. The literature is removed from a hopper and placed on a rotary drum. The drum holds the literature by vacuum and is rotated to a station that applies glue to the back of the literature. The drum is then rotated to another station where the literature is applied directly onto a container. This method of applying a piece of literature to the container, however, is messy and inaccurate. In an alternative to this procedure, a container is positioned on a platform that is eccentric. The hotmelt glue is applied to the side of a container. When the container nears the outsert, dual feed screws accelerate the outsert to meet the glue on the container. When the container nears the outsert, the container is rotated on the platform and the glue pulls the outsert out of the hopper. In this method the container actually hits the outsert at the magazine discharge and the only thing that actually pulls the outsert out of the hopper is the adhesive strength of the glue.

The system described in detail in U.S. Pat. No. 5,336,359 (the disclosure of which is incorporated herein by reference) overcomes many of the disadvantages inherent in the above-described literature-applying machines by providing a rotatable member which receives literature from a hopper and is rotated to a station that applies the literature to an adhesively coated web. The rotatable member of that device is rotated such that only a single piece of literature is received by each literature receiving area on the rotatable member. The system includes a hopper having an exit for dispensing literature one piece at a time and a rotatable member having a plurality of literature-receiving areas disposed around the periphery thereof. Each literature-receiving area receives one piece of literature from the exit. The member is positioned such that a portion of the periphery thereof is in facing relationship with the exit of the hopper for allowing one of the literature-receiving areas to be aligned with the exit for receiving the one piece of dispensed literature. Drive means is operatively associated with the member for rotating the member in a first direction such that the literature-receiving areas pass by the exit one at a time to correspondingly receive a piece of literature from the exit of the hopper. A web having an adhesive coating on one side thereof is provided for receiving and carrying pieces of literature. Guide means guide the web past a literature-receiving area of the member having a terminal piece of literature positioned thereon such that the adhesive coating on the web is in facing relationship with the terminal piece of literature. First transfer means transfers the terminal piece of literature from the literature-receiving area having the terminal piece of literature therein into adhering contact with the adhesive coating on the web. Moving means moves the web past the first transfer means toward an object which is to receive a piece of literature. Second transfer means transfers a piece of literature from the web to the object. Means are provided to receive the web after removal of literature therefrom by the second transfer means.

### BRIEF SUMMARY OF THE INVENTION

The outserter of the present invention is an electro-mechanical system used by the pharmaceutical industry to automatically apply an outsert (professional information brochure) to the outside of a pharmaceutical container without the need for webs, pressure sensitive tapes, a vacuum wheel or a vacuum star to deliver the outsert from the outsert magazine to the designated container. Instead, this outserter utilizes a star wheel designed to extract outserts out of the hopper magazine without vacuum. Once the outsert is extracted, the star accelerates the outsert to match the velocity of the container to which it is to be adhered. Hotmelt glue is applied to the target side of the designated container or, alternatively, to the leading face of the extracted outsert and the two are brought into contact with each other to complete the outsert placement and attachment. A key element of this outsert placer can be an added option for and/or retrofit to a rotary or in-line labeling system. While previous oursert placers using glue-laden tape to bond an outsert to a container, the direct glue application permits an increase in outserter speed of from about 300 inserts per minute to about 500 inserts per minute.

### BRIEF DESCRIPTION OF THE DRAWINGS

FIG. 1 is a fragmentary side elevational view of an outsert placer constructed in accordance with the teachings of this invention.

FIG. 2 is a top plan view of the outsert placer of FIG. 1 installed adjacent to a conveyor line for outsert application to containers on such line.

FIG. 3A and FIG. 3B are enlarged, detailed, fragmentary views of key aspects of the outsert placer shown in FIG. 2.

FIG. 4A, FIG. 4B and FIG. 4C are enlarged, detailed, fragmentary views of elements shown in FIG. 3A.

FIG. 5 is an enlarged view of the key parts of the outsert placer shown in FIG. 2 illustrating the onset of an outsert application to a container.

FIG. 6 is an enlarged view of the key parts of the outsert placer shown in FIG. 2 illustrating the conclusion of an outsert application to a container.

### DETAILED DESCRIPTION OF THE INVENTION

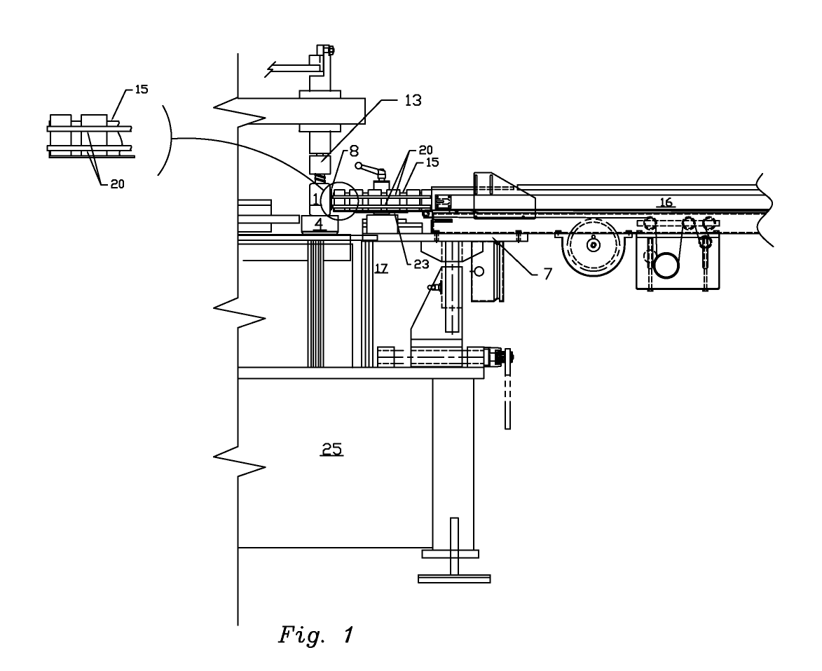

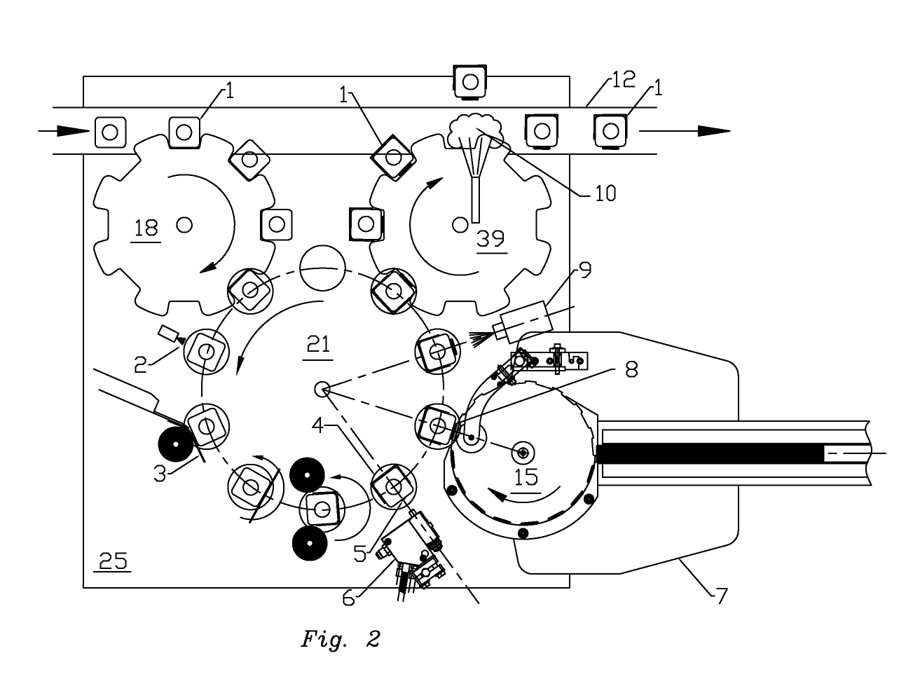

FIGS. 1 and 2 show the outserter as used with a rotary labeling machine. As the container enters a rotary labeling machine (25), a top hold device (13) applies downward pressure to a container (1) that is sitting on a high grip rubber platform (4). The container (1) is detected by a photoelectric device (2) and tracked by the machine controller through the system. The container is first labeled (3) as the container travels through the machine. The container is then positioned by rotation of the platform (4) to the appropriate orientation to receive the outsert. It then reaches the location where two beads of hot-melt glue are applied (5) by an air operated automatic glue head (6). Traveling another 36 degrees, the container reaches the outsert placer (7). Here the outsert (8) is applied to the side of the container and held in place by the hot-melt glue. Applying glue to the outsert instead of the container is an optional method. Traveling another 36 degrees the outsert is inspected by the inspection device (9) and determined to be accepted or rejected. Upon exiting the machine the container (1) with the outsert applied is either rejected with an air blast (10) or proceeds down the conveyor (12) as a good container (1).

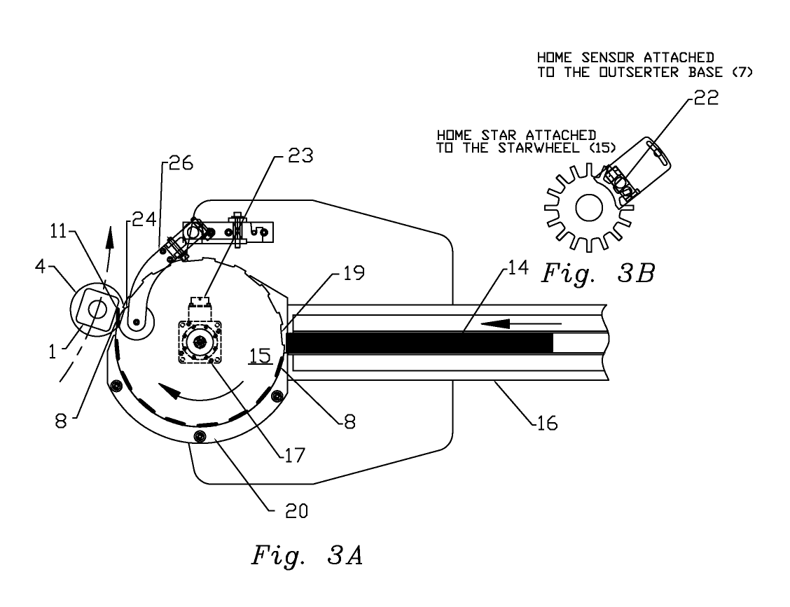

As can be seen with greater clarity in FIG. 3, outserts (8) are delivered in bulk to the star wheel (15) by means of a feeder mechanism (16). The star wheel is driven by a servo motor (17) mounted directly under the star wheel. The outserts (8) are separated individually in the pockets (19) of the star wheel and held in place by guides (20). The outserts (8) are indexed to the application point (11) at a matched velocity of the container (1) ensuring a smooth transition from star wheel to the container (1) via the servo motor. The start/stop position of the star wheel is adjustable by rotating the star home sensor (22) as it registers one of the teeth of the home sensor star (23) and the outsert (8). The outsert is applied to the side of the container, which has had hot-melt glue previously applied, by the force of a pressure wheel (24).

Mounting plate (27) attaches the entire assembly to the outserter base plate (7). Bearing plate (28) is attached to mounting plate (27) via locking handle (38) which locks impression roller (24) in a fixed position while locking bearing plate (28) to mounting plate (27). Bearing plate (28) can swing out to set up the machine via locking handle (38). Spring bar (30) is attached to bearing plate (28) via shoulder screw (37). Pivot post (31) is attached to spring bar (30) via locking screws (39). Pivot arm (32) is attached to pivot arm (31) via locking screw (41). Locking screw (41) allows the mechanic to adjust the relative position of roller (24) in relation to a bottle (5). Locking screw (40) adjusts roller arm (33) and pivot arm (32) so that the relative position of roller (24) in relationship to the star wheels (15) allows the outsert (8) to be applied sooner or later to the bottle (5). Curved sandwich plates (26) are attached to roller arm (33) via locking screws (42). Impression roller (24) is attached to the curved sandwich plates (26) via axle (34).

The previous design of the outsert application roller assembly was very hard to set up. The pressure of the roller that was applied to the outsert to the container was uneven. The previous design gave less pressure at the initial contact to the container and more pressure at the end of the application. This caused the outserts to flip off the container due to the uneven pressure. Training mechanics to utilize the previous device was very tedious due to the critical nature of this previous setup. This new improved outsert application roller mechanism allows the mechanics to set up the machine very quickly and with minimal adjustments.

The application roller mechanism has a curved shape arm that spreads the roller pressure evenly during the entire outsert application to the container. The curved arm also acts as a guide and pressure shoe allowing the outsert to adhere to the container while the glue is setting up, i.e. drying. This pressure arm is designed to align radially with the circumference travel of the container as it passes the outserter. Depending on the outserter location, the arm curvature must be changed to ensure it is lined up with the container travel.

The application point angle is very critical to ensure a good tack point. Due to the various thicknesses of the outserts, the angled arm must fall within +/−10 degrees of the designed angle to ensure proper application. In a preferred embodiment, the outside radius of the arm is 4.226 inches and the angle is 45 degrees.

While the invention has been illustrated by means of the preferred embodiment, with the outsert placer coacting with a rotary labeling machine, it may be adapted by routine engineering to other common labeling machines such as the in-line labelers without losing the advantages provided by the present invention including, for example, equipment simplification.

What is claimed is:

1. A device substantially as shown and described.

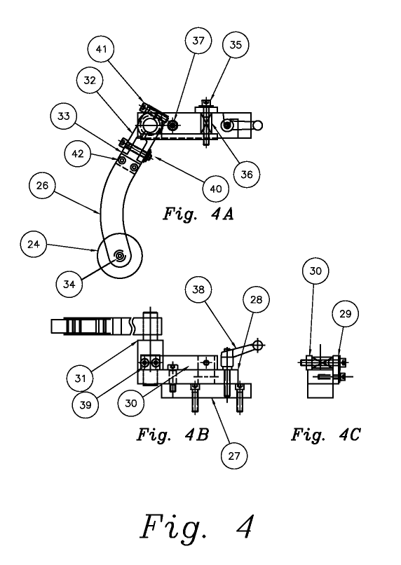

2. A device substantially as shown and described in FIGS. 3 and 4.

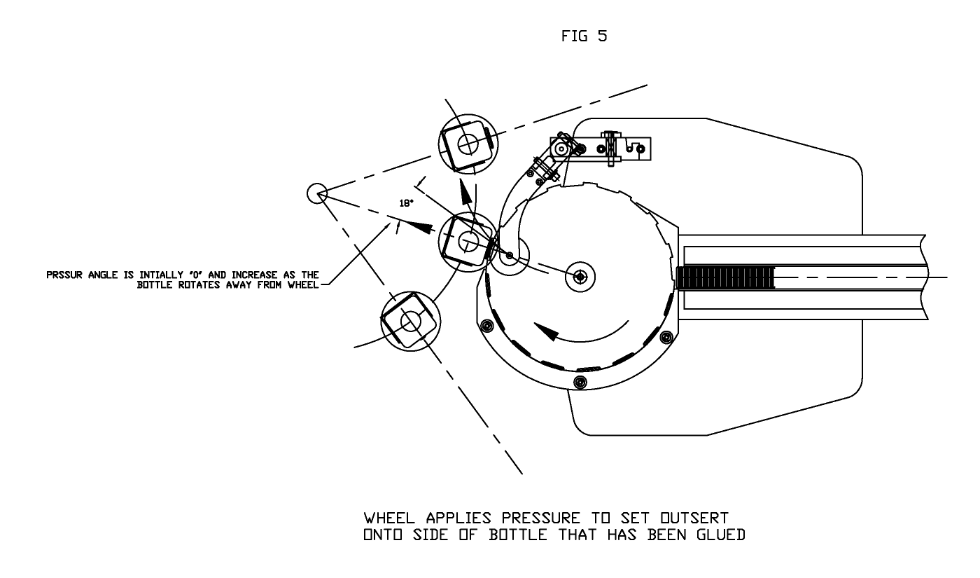

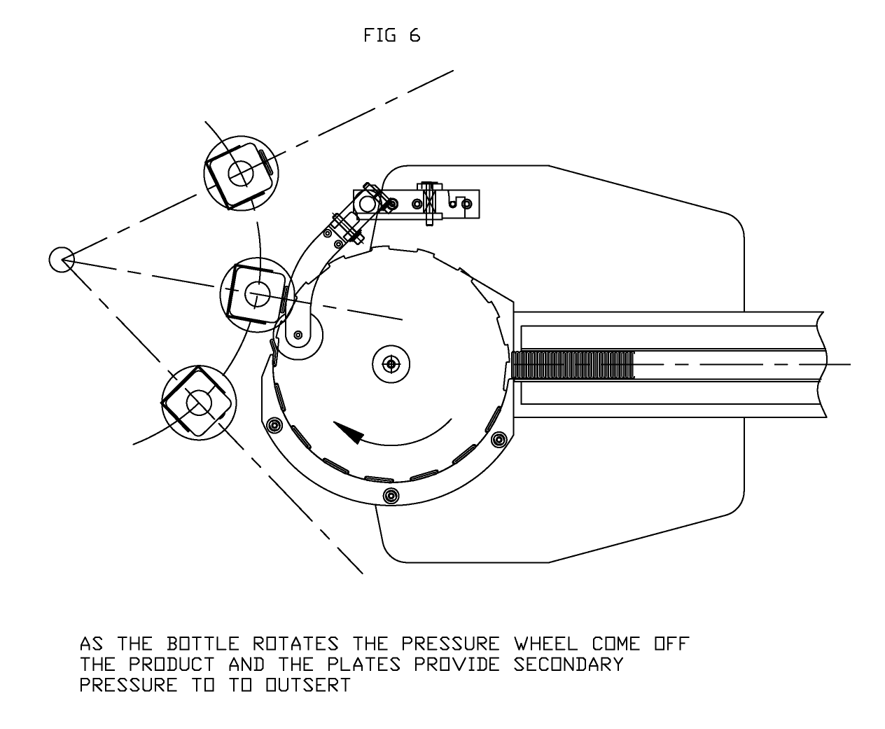

3. A device in accordance with claim 2, substantially as shown and described in FIGS. 5 and 6.
